(19) United States
(12) Patent Application Publication
(10) Pub. No.: US 2015/0303573 A1
(43) Pub. Date: Oct. 22, 2015

(54) ANTENNA DEVICE

(71) Applicant: TDK CORPORATION, TOKYO (JP)

(72) Inventors: TOSHIO TOMONARI, TOKYO (JP); Hirohumi ASOU, TOKYO (JP); Toshifumi KOMACHI, TOKYO (JP)

(73) Assignee: TDK CORPORATION, TOKYO (JP)

(21) Appl. No.: 14/696,899

(22) Filed: Apr. 27, 2015

(30) Foreign Application Priority Data
Apr. 20, 2014 (JP) 2014-093530

(51) Int. Cl. H01Q 7/00; H01Q 7/06

(52) U.S. Cl. CPC H01Q 7/00; H01Q 7/06

(57) ABSTRACT

A coil component is provided with a substrate; an antenna coil formed into a loop-shaped or spiral-shaped on the substrate; and first and second metallic layers disposed so as to overlap the antenna coil in a planar view and to form a slit sandwiched the first and second metallic layers. The slit overlaps with an inner diameter portion of the antenna coil . At least one of the first and second metallic layers is formed into a loop shape having an opening. The antenna coil overlaps with the opening of at least one of the first and second metallic layers in a planar view.

### BACKGROUND OF THE INVENTION

1. Field of the Invention

The present invention relates to an antenna device and, more particularly, to an antenna device suitable for NFC (Near Field Communication).

2. Description of Related Art

In recent years, a mobile electronic device such as a smartphone is equipped with an RFID (Radio Frequency Identification: individual identification by radio waves) system and further equipped with, as a communication means of the RFID, an antenna for performing near field communication with a reader/writer and the like.

Further, the mobile electronic device is provided with a metallic shield so as to protect a built-in circuit from external noise and to prevent unnecessary radiation of noise generated inside the device. Particularly, recently, a housing itself of the mobile electronic device is made of metal instead of resin, considering thinness, light weight, durability against drop impact, design, and the like. Cases where the metallic housing doubles as the metallic shield have been increasing. However, since generally the metallic shield shields electric waves, when an antenna needs to be provided, it is necessary to arrange the antenna at a position not overlapping the metallic shield. When the metallic shield is arranged over a wide range, arrangement of the antenna becomes a serious problem.

To solve the above problem, in antenna devices disclosed in, e.g., Japanese Patent No. 4,687,832 and Japanese Patent Application Laid-Open No. 2002-111363, an opening is formed in a conductive layer, a slit connecting the opening and an outer edge is formed, and an antenna coil is arranged such that an inner diameter portion thereof overlaps with the opening. In this configuration, current flows in the conductive layer so as to shield a magnetic field generated by flowing of current in a coil conductor, and the current flowing around the opening of the conductive layer passes around the slit, with the result that current flows also around the conductive layer by edge effect. As a result, a magnetic field is generated also from the conductive layer, and the conductive layer makes a large loop of a magnetic flux, thereby increasing a communication distance between the antenna device and an antenna of an apparatus at a communication partner side. That is, it is possible to allow the conductive layer to function as an accelerator for increasing a communication distance of the antenna coil.

Further, Japanese Patent Application Laid-Open No. 2014-27389 discloses an antenna device having a configuration in which a part of a conductor plate having an opening inside thereof is arranged so as to overlap with apart of a coil. When the opening is formed in the conductor plate, an eddy current tends to flow while avoiding the opening, with the result that the eddy current is concentrated to a high density on the conductor plate above the coil. This can increase magnetic coupling between the high-density eddy current and the coil and improve communication characteristics.

In the conventional antenna devices described in Japanese Patent No. 4,687,832 and Japanese Patent Application Laid-Open No. 2002-111363, the conductive layer has a solid metallic surface (solid pattern) as a whole, so that a large floating capacitance is generated between the conductive layer having a large planar size and the coil conductor, making it difficult to achieve antenna frequency matching. in the frequency matching, a desired resonance frequency is set by adding capacitance to an antenna circuit. However, when the capacitance has already been very large due to the floating capacitance, adjustment of the frequency by the addition of the capacitance is difficult.

### SUMMARY

Therefore, an object of the present invention is to provide an antenna device capable of easily achieving frequency matching while ensuring a communication distance of the antenna. Another object of the present invention is to provide a mobile electronic device with high performance constructed using such an antenna device.

To solve the above problem, an antenna device according to the present invention includes a substrate, an antenna coil formed into loop-shaped or spiral-shaped on the substrate, and first and second metallic layers disposed so as to overlap with the antenna coil in a planar view and to form a slit sandwiched the first and second metallic layers, wherein the slit overlaps with an inner diameter portion of the antenna coil, at least one of the first and second metallic layers is formed into a loop shape having an opening, and the antenna coil overlaps with the opening of at least one of the first and second metallic layers in a planar view.

According to the present invention, the first and second metallic layers make a large loop of a magnetic flux, thereby increasing a communication distance of the antenna device. Further, at least one of the first and second metallic layers constitutes a loop pattern, not a so-called solid pattern, thereby reducing a floating capacitance between at least one of the first and second metallic layers and the antenna coil, which can make it easy to achieve antenna frequency matching.

In the present invention, it is preferable that both of the first and second metallic layers are formed into a loop shape having an opening in a planar view, and that the antenna coil is disposed so as to overlap with each of the openings of both the first and second metallic layers in a planar view. With this configuration, the floating capacitance to be generated between the first and second metallic layers and the antenna coil can be reduced further, thereby making it easy to achieve antenna frequency matching.

In the present invention, it is preferable that the antenna coil is formed on one main surface of the substrate, and that the first and second metallic layers are formed on the other main surface of the substrate. With this configuration, the first and second metallic layers are positioned accurately with respect to the antenna coil, thereby facilitating handling and installation of the antenna device and improving antenna characteristics.

It is preferable that the antenna device according to the present invention further includes third and fourth metallic layers provided so as to overlap with the antenna coil in a planar view. Further, it is preferable that both of the third and fourth metallic layers are formed into a loop shape having an opening in a planar view, and that the antenna coil is disposed so as to overlap with each of the openings of the respective first to fourth metallic layers in a planar view. In this configuration, a magnetic flux penetrating the inner diameter portion of the antenna coil passes through an area surrounded by each of the first to fourth metallic layers, so that a path of the magnetic flux can be concentrated on the inner diameter portion, thereby increasing a communication distance of the antenna. Further, by additionally providing the third and fourth metallic layers each having a relatively smaller size, it is possible to increase a loop size of the magnetic flux while reducing a loss of the magnetic flux that interlinks with the antenna coil, thereby increasing a communication distance further effectively.

In the present invention, it is preferable that the first metallic layer has a solid metallic surface as a whole, and that the second metallic layer is formed into a loop shape having an opening in a planar view. In this case, a configuration may be possible, in which the antenna coil is formed on one main surface of the substrate, and the first and second metallic layers are formed on the other main surface of the substrate. Further, a configuration may be possible, in which the antenna coil is formed on one main surface of the substrate, the first metallic layer is provided so as to be separated from the substrate, and the second metallic layer is formed on the other main surface of the substrate. According to the latter configuration, a metallic body constituting a housing of a mobile electronic device such as a smartphone in which the antenna device is mounted can be used as the second metallic layer, thereby eliminating the need to use a dedicated metallic layer for constituting the first metallic layer, thereby reducing material cost and weight of the mobile electronic device.

In the present invention, it is preferable that a line width of the loop shape of at least one of the first and second metallic layers is constant over the entire periphery thereof. With this configuration, current flowing in the loop pattern is stabilized, thereby allowing the antenna device to stably perform communication.

It is preferable that the antenna device according to the present invention further includes a metallic body provided so as to overlap with the antenna coil in a planar view and a magnetic sheet provided between the antenna coil and the metallic body. With this configuration, it is possible to ensure a magnetic path of a magnetic loop that interlinks with the antenna coil, thereby reducing influence of the metallic body.

It is preferable that the antenna device according to the present invention further includes a center metallic layer provided so as to overlap with at least a center portion of the inner diameter portion of the antenna coil, and that the first and second metallic layers are disposed on both sides of the center metallic layer, respectively, so as to be sandwiched between the first and second metallic layers. With this configuration, particularly when the metallic body is disposed at a position distant from the antenna coil, it is possible to reduce influence of the metallic body, thereby increasing a communication distance of the antenna.

According to the present invention, an antenna device capable of increasing a communication distance of the antenna coil and facilitating frequency matching can be provided. Further, according to the present invention, a mobile electronic device with high performance constructed using such an antenna device can be provided.

### BRIEF DESCRIPTION OF THE DRAWINGS

The above features and advantages of the present invention will be more apparent from the following description of certain preferred embodiments taken in conjunction with the accompanying drawings, in which:

FIG. 1A is a plan view illustrating a configuration of an antenna device according to a first embodiment of the present invention;

FIG. 1B is a transparent view of the antenna coil when viewed from the same direction as FIG. 1A;

FIG. 2 is a cross-sectional view of the antenna device taken along a line Y-Y′ of FIG. 1A;

FIG. 3 is a plan view for explaining action of first and second metallic layers to the antenna coil;

FIG. 4 is a cross-sectional view for explaining action of the first and second metallic layers to the antenna coil;

FIG. 5 is a plan view illustrating a configuration of an antenna device according to a second embodiment of the present invention;

FIG. 6 is a cross-sectional view illustrating the configuration of the antenna device according to the second embodiment of the present invention;

FIG. 7 is a plan view illustrating a configuration of an antenna device according to a third embodiment of the present invention;

FIG. 8 is a cross-sectional view illustrating the configuration of the antenna device according to the third embodiment of the present invention;

FIG. 9 is a plan view illustrating a configuration of an antenna device according to a fourth embodiment of the present invention;

FIG. 10 is a cross-sectional view illustrating the configuration of the antenna device according to the fourth embodiment of the present invention;

FIG. 11 is a plan view illustrating a configuration of an antenna device according to a fifth embodiment of the present invention;

FIG. 12 is a plan view illustrating a configuration of an antenna device according to a sixth embodiment of the present invention;

FIG. 13 is a cross-sectional view illustrating the configuration of the antenna device according to the sixth embodiment of the present invention; and

FIGS. 14A to 14C are cross-sectional views illustrating variations of arrangement of first and second metallic layers in the antenna device according to the sixth embodiment of the present invention.

### DETAILED DESCRIPTION OF THE EMBODIMENTS

Preferred embodiments of the present invention will be explained below in detail with reference to the accompanying drawings.

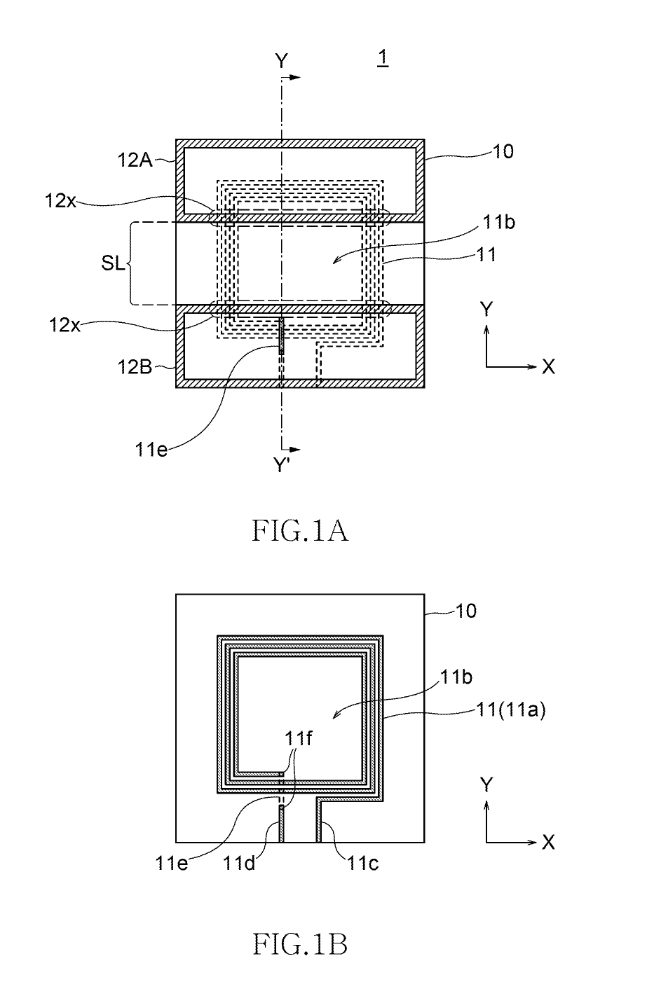

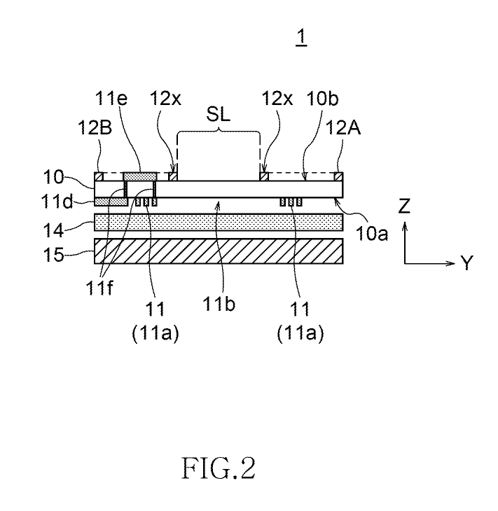

FIGS. 1A and 1B are plan views each illustrating a configuration of an antenna device according to a first embodiment of the present invention. Particularly, FIG. 1B is a view transparently illustrating the antenna coil when viewed from the same direction as FIG. 1A. FIG. 2 is a cross-sectional view of the antenna device taken along a line Y-Y′ of FIG. 1A.

As illustrated in FIGS. 1A and 1B and FIG. 2, an antenna device 1 includes a substrate 10, a spiral antenna coil 11 formed on the substrate 10, first and second metallic layers 12A and 12B provided so as to overlap with the antenna coil 11 in a planar view, and a magnetic sheet 14 provided on a side opposite to the first and second metallic layers 12A and 12B with respect to the antenna coil 11.

The substrate 10 is, e.g., a flexible substrate made of PET resin and has a planar size of 40 mm×50 mm and a thickness of about 30 μm. The antenna coil 11 has a substantially rectangular spiral pattern 11a and is formed mainly on one main surface 10a (lower surface) of the substrate 10. The antenna coil 11 may be formed by plating or by etching (patterning) of a metallic layer previously formed on the entire surface of the substrate 10.

Both ends of the spiral pattern 11a of the antenna coil 11 are led to an edge of the substrate 10 by lead sections 11c and 11d. Particularly, an inner peripheral end of the spiral pattern 11a is led outside the loop through a bridge section 11e crossing the loop of the spiral and through-hole conductors 11f penetrating the substrate 10. The both ends of the antenna coil 11 are connected to, e.g., a main circuit substrate. The connection method is not especially limited. For example, the lead sections 11c and 11d may be extended together with the substrate 10 made of a flexible material so as to be connected to the main circuit substrate. Alternatively, a power feed pin may be used for the connection.

In the present embodiment, the bridge section 11e is formed on the other main surface 10b of the substrate 10. One end and the other end of the bridge section 11e are connected, respectively, to the inner peripheral end of the spiral pattern 11a and one end of the lead section 11d through the through-hole conductors 11f and 11f. The antenna coil 11 is formed by only patterns formed directly on the one and the other main surfaces 10a and 10b of the substrate 10, so that it is not necessary to laminate additional metallic layer for formation of the bridge section 11e, thus facilitating formation of the bridge section 11e. Particularly, the bridge section 11e is provided inside the loop shape of the second metallic layer 12B, so that the bridge section 11e does not interfere with the second metallic layer 12B, thus providing easy layout of the bridge section 11e.

The first and second metallic layers 12A and 12B are formed on the other main surface 10b of the substrate 10. A planar shape of each of the first and second metallic layers is a loop shape (loop pattern) having inside thereof an opening. in a conventional antenna device in which the first and second metallic layers 12A and 12B are each formed into a so-called solid pattern, a large floating capacitance is generated between the first and second metallic lavers 12A and 12B and the antenna coil 11, making it difficult to achieve matching at a target frequency (e.g., 13.56 MHz) due to addition of a capacitance in frequency matching. However, when the first and second metallic layers 12A and 12B are each formed in a loop pattern, it is possible to reduce the floating capacitance between the first and second metallic layers 12A and 12B and the antenna coil 11, making it easy to achieve antenna frequency matching.

A metallic body 15 is provided at a position more distant than the magnetic sheet 14 from the antenna coil 11. The metallic body 15 is, e.g. , a battery case of a mobile electronic device such as a smartphone in which the antenna device 1 is mounted. By interposing the magnetic sheet 14 between the antenna coil 11 and the metallic body 15, it is possible to reduce influence that the metallic body 15 exerts on the antenna coil 11 and to increase inductance, thereby improving antenna characteristics.

A line width of the loop pattern of each of the first and second metallic layers 12A and 12B is preferably constant over the entire periphery thereof. By making the line width constant, current flowing in the loop pattern is stabilized, thereby allowing the antenna device to stably perform communication. The line width need not completely be constant, and a slight variation in the line width is allowed. Specifically, a pattern with a thicker line width maybe equal to or less than double a pattern with a narrower line. Particularly, a width of a linear part that extends in an X direction and crosses an inner diameter portion 11b of the antenna coil 11 is preferably larger than a width of another linear part.

A slit SL having a constant width is provided between the first and second metallic layers 12A and 12B, and the first and second metallic layers 12A and 12B are electrically isolated by the slit SL. A width of the slit SL is preferably smaller than a width of the inner diameter portion 11b of the antenna coil 11 in the same direction (Y direction). The slit SL is provided at a center of the substrate 10 in a width direction thereof so as to cross the inner diameter portion 11b of the antenna coil 11. That is, the antenna coil 11 is laid out such that the inner diameter portion 11b thereof overlaps with the slit SL in a planar view.

The openings of the first and second metallic layers 12A and 12B each preferably partially overlap with the inner diameter portion 11b of the antenna coil 11. That is, preferably a part 12X of the loop pattern of each of the first and second metallic layers 12A and 12B that overlaps with a formation region of the antenna coil 11 is disposed not immediately above the spiral pattern 11a of the antenna coil 11 but at a position near the center of the inner diameter portion lib. With this arrangement, current to be generated by a magnetic flux φ of the antenna coil 11 and to flow in the loop patterns of the first and second metallic layers 12A and 12B can be stably generated.

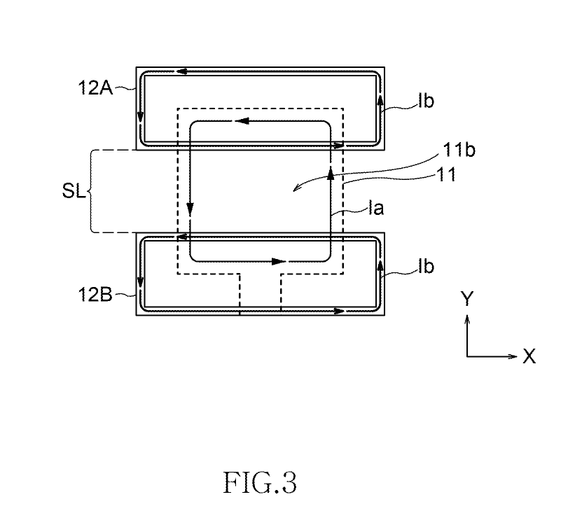

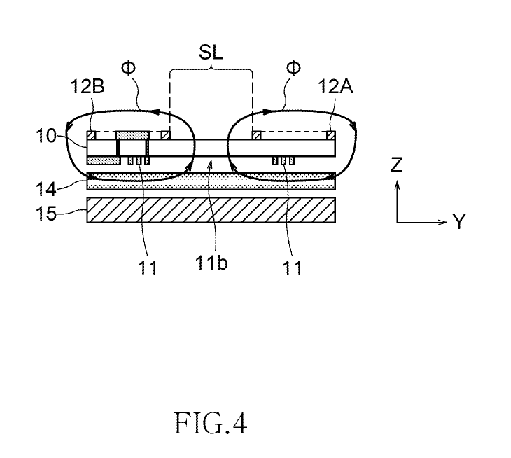

FIGS. 3 and 4 are views for explaining action of the first and second metallic layers 12A and 12B to the antenna coil 11. FIG. 3 is a plan view and FIG. 4 is a cross-sectional view.

As illustrated in FIGS. 3 and 4, when a counterclockwise current Ia flows in the antenna coil 11, the magnetic flux φ to penetrate the inner diameter portion 11b of the antenna coil 11 is generated. This magnetic flux φ passes through the slit SL disposed between the first and second metallic layers 12A and 12B and interlinks with the first and second metallic layers 12A and 12B. On the other hand, current generated by the magnetic flux flows in the first and second metallic layers 12A and 12B. This current becomes a loop current Ib. The loop current Ib flows in the counterclockwise direction like the current Ia flowing in the antenna coil 11.

The magnetic flux φ that has passed through the slit SL tends to go by roundabout routes each of which makes the slit SL disposed between the first and second metallic layers 12A and 12B the inside and makes an outer edge of each of the first and second metallic lavers 12A and 12B the outside. As a result, the magnetic flux interlinks with an antenna coil of a reader/writer while depicting a relatively large loop, with the result that the antenna device 1 is magnetically coupled to an antenna of an apparatus at a communication partner side. Particularly, since a planar size of an outer periphery of the entire metallic layer including the first and second metallic layers 12A and 12B and slit SL is larger than a planar size of the antenna coil 11, a large loop magnetic field can be generated. Further, the magnetic sheet 14 is provided on a side opposite to the first and second metallic layers 12A and 12B with respect to the antenna coil 11, so that it is possible to increase inductance while ensuring magnetic path of the magnetic flux φ, thereby improving antenna characteristics.

When the first and second metallic layers 12A and 12B are each formed into a solid pattern as in the conventional way, an eddy current does not flow in a center portion of the solid pattern. Thus, it can be said that the center portion of the solid pattern does not substantially function as a current path. Thus, even when the center portion of the solid pattern is removed to forma loop pattern, current can be made to flow. The removal of the center portion of the solid pattern can reduce the floating capacitance generated between the first and second metallic layers 12A and 12B and the antenna coil 11, thereby making it easy to achieve antenna frequency matching.

As described above, in the antenna device 1 according to the present embodiment, the first and second metallic layers 12A and 12B make the loop of the magnetic flux φ of the antenna coil 11 widely circulate, thereby increasing a communication distance from the antenna device 1 to an antenna of an apparatus at a communication partner side. Further, the first and second metallic layers 12A and 12B each formed in a loop pattern, thereby reducing the floating capacitance between the first and second metallic layers 12A and 12B and the antenna coil 11, which can make it easy to achieve antenna frequency matching.

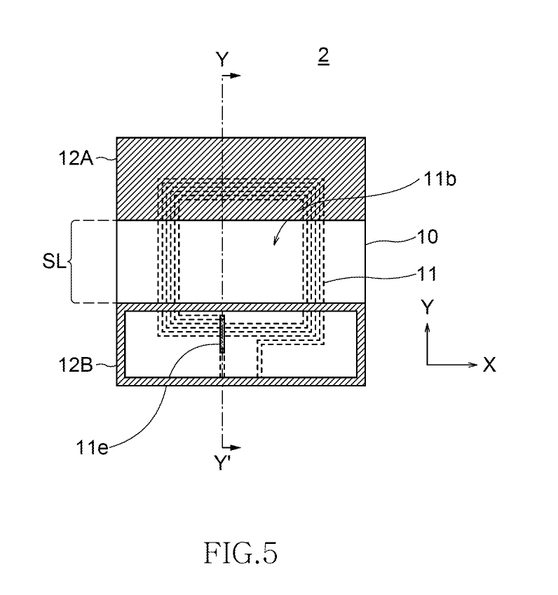

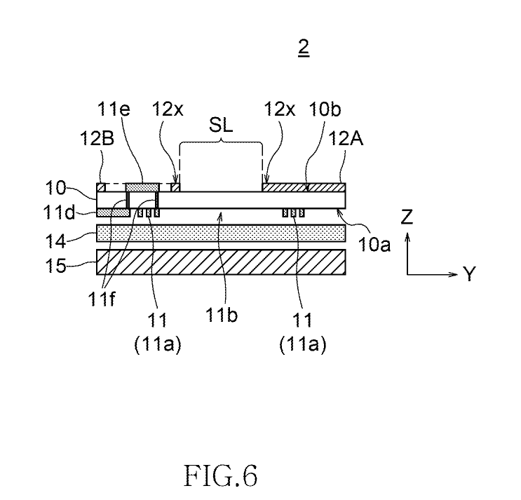

FIGS. 5 and 6 are views each illustrating a configuration of an antenna device according to a second embodiment of the present invention. FIG. 5 is a plan view, and FIG. 6 is a cross-sectional view.

As illustrated in FIGS. 5 and 6, an antenna device 2 of the present embodiment is characterized in that the first metallic layer 12A is not formed into a loop pattern, but into a solid pattern. That is, only the second metallic layer 12B is formed into a loop pattern, and the first metallic layer 12A has a solid metallic surface as a whole. Other configurations are the same as those of the first embodiment.

As described above, in the antenna device 2 according to the present embodiment, the second metallic layer 12B is formed into a loop pattern, so that the floating capacitance between the second metallic layer 12B and the antenna coil 11 can be reduced, thereby making it easy to achieve antenna frequency matching. Although the first metallic layer 12A is formed into a solid pattern and the second metallic layer 12B is formed into a loop pattern in the present embodiment, a reverse configuration may be employed, in which the first metallic layer 12A is formed into a loop pattern and the second metallic layer 12B is formed into a solid pattern. That is, it is only necessary for one of the first and second metallic layers 12A and 12B to have a loop pattern and for the other one to have a sold pattern.

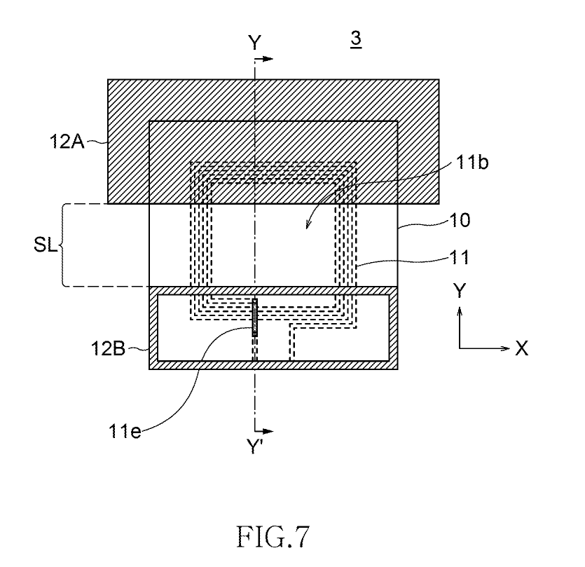

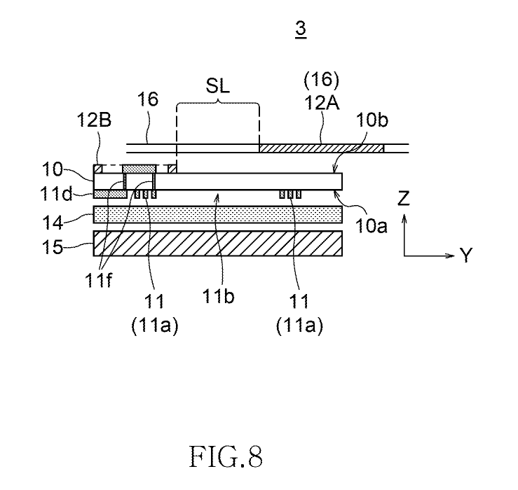

FIGS. 7 and 8 are views each illustrating a configuration of an antenna device according to a third embodiment of the present invention. FIG. 7 is a plan view, and FIG. 8 is a cross-sectional view.

As illustrated in FIGS. 7 and 8, an antenna device 3 according to the present embodiment is characterized in that the first metallic layer 12A having a solid metallic surface as a whole is provided so as to be separated from the substrate 10, and only the second metallic layer 12B is formed so as to contact the other main surface 10b of the substrate 10. Specifically, the first metallic layer 12A constitutes a part of a housing 16 of a mobile electronic device such as a smartphone in which the antenna device 3 is mounted. As described above, in recent years, a housing itself of the mobile electronic device is made of metal instead of resin, and the metallic housing is often used also as the metallic shield. Therefore, by utilizing a metallic body constituting the housing 16 as the first metallic layer 12A, it is possible to eliminate the need to use a dedicated metallic layer for constituting the first metallic layer 12A, thereby reducing material cost and weight of the mobile electronic device.

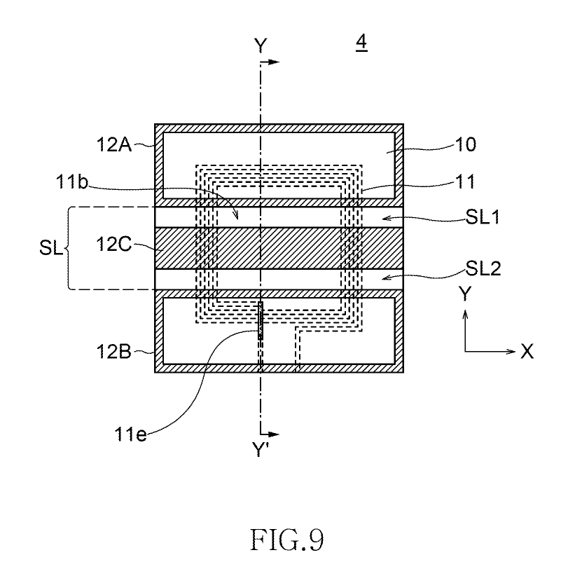

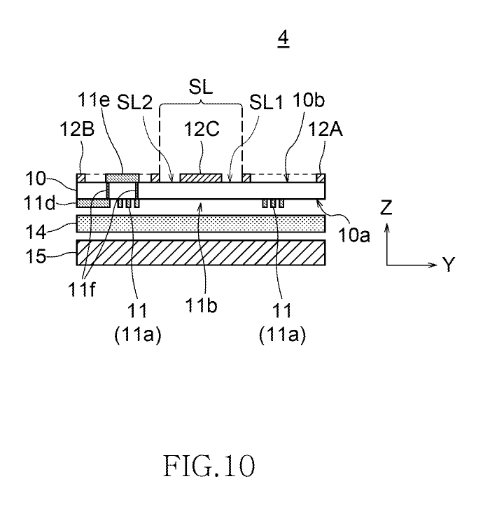

FIGS. 9 and 10 are views each illustrating a configuration of an antenna device according to a fourth embodiment of the present invention. FIG. 9 is a plan view and FIG. 10 is a cross-sectional view.

As illustrated in FIGS. 9 and 10, an antenna device 4 according to the present invention is characterized in that a center metallic layer 12C is provided between the first and second metallic layers 12A and 12B. The center metallic layer 12C has an elongated rectangular pattern extending in parallel to the slit SL and is sandwiched between the first and second metallic layers 12A and 12B. As a result, the slit SL is divided into first and second slits SL1 and SL2. The inner diameter portion 11b of the antenna coil 11 overlaps with the two slits SL1 and SL2 in a planar view. Other configurations are the same as those of the first embodiment.

Although not especially limited, the two slits SL1 and SL2 preferably have the same width. A width of the center metallic layer 12C in a Y-direction is preferably larger than a width of each of the slits SL1 and SL2; however, when being excessively larger, the width of each of the slits SL1 and SL2 becomes excessively small, so that the width of the center metallic layer 12C needs to be set to an appropriate size. A width of the slit SL before division needs to be smaller than the width of the inner diameter portion 11b of the antenna coil 11. The center metallic layer 12C need not be an elongated pattern having the same length as that of the slit SL, but only needs to be provided so as to overlap with at least a center position of the inner diameter portion of the antenna coil 11 in a planar view.

The antenna device 4 according to the present embodiment can provide equivalent or greater effect than that obtained in the first embodiment. That is, a combination of the first and second metallic layers 12A and 12B and the center metallic layer 12C makes the magnetic flux of the antenna coil 11 widely circulate, thereby increasing a communication distance of the antenna device. The present embodiment is particularly effective for a case where the metallic body 15 is provided at a position more distant from the antenna coil 11. That is, when the center metallic layer 12C is provided to divide the slit SL into the two slits SL1 and SL2 in a configuration where the metallic body 15 positioned at a side opposite to the antenna coil 11 with respect to the magnetic sheet 14 is comparatively distant from the antenna coil 11, it is possible to reliably increase a communication distance as compared with a case where the center metallic layer 12C is not provided.

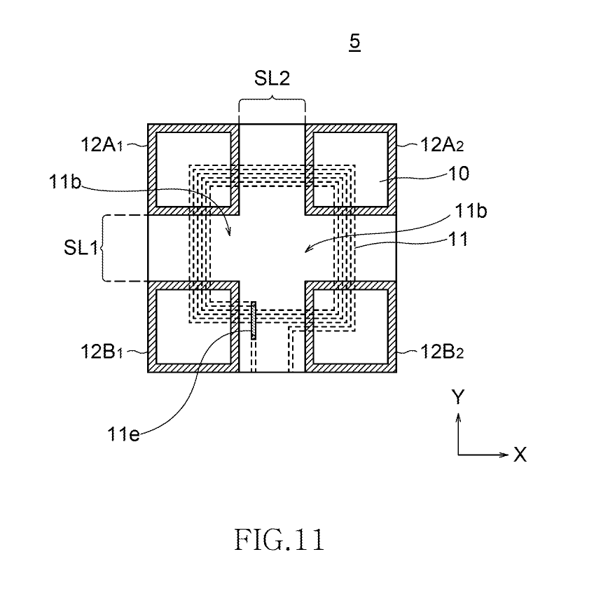

FIG. 11 is a plan view illustrating a configuration of an antenna device according to a fifth embodiment of the present invention.

As illustrated in FIG. 11, an antenna device 5 according to the present embodiment is characterized in that each of the first and second metallic layers 12A and 12B in the configuration illustrated in FIG. 1 is divided into two. That is, the antenna device 5 includes a first metallic layer 12A₁, a second metallic layer 12A₂, a third metallic layer 12B₁, and a fourth metallic layer 12B₂. The first metallic layer 12A₁, second metallic layer 12A₂, third metallic layer 12B₁, and fourth metallic layer 12B₂ are laid out point symmetrically with respect to a center of the inner diameter portion 11b of the antenna coil 11.

When current flows in the antenna coil 11, the magnetic flux penetrating the inner diameter portion 11b of the antenna coil 11 passes through the slits SL1 and SL2 and interlinks with the first to fourth metallic layers 12A₁, 12A₂, 12B₁, and 12B₂. The slit SL1 is a lateral direction slit (an X-direction slit) including an area sandwiched between the first metallic layer 12A₁ and the third metallic layer 12B₁ and an area sandwiched between the second metallic layer 12A₂ and the fourth metallic layer 12B₂. The slit SL2 is a longitudinal direction slit (a Y-direction slit) including an area sandwiched between the first metallic layer 12A₁ and the second metallic layer 12A₂ and an area sandwiched between the third metallic layer 12B₁ and the fourth metallic layer 12B₂. The slits SL1 and SL2 are perpendicular to each other.

Currents generated by the magnetic flux flow in loop patterns of the respective first to fourth metallic layers 12A₁, 12A₂, 12B₁, and 12B₂. The current generated in each of the first to fourth metallic layers 12A₁, 12A₂, 12B₁, and 12B₂ flows in the counterclockwise direction like the current flowing in the antenna coil 11.

Then, the magnetic flux tends to go by a roundabout routes each of which makes an outer edge of each of the first to fourth metallic layers 12A₁, 12A₂, 12B₁, and 12B₂ the outside. As a result, the magnetic flux φ interlinks with an antenna coil of a reader/writer while depicting a relatively large loop, with the result that the antenna device 5 is magnetically coupled to an antenna of an apparatus at a communication partner side. Particularly, since the total cover area of the first to fourth metallic layers 12A₁, 12A₂, 12B₁, and 12B₂ is larger than an area of the antenna coil 11, a large loop magnetic field can be generated. Further, the magnetic sheet 14 is provided on a side opposite to the first to fourth metallic layers 12A₁, 12A₂, 12B₁, and 12B₂ with respect to the antenna coil 11, so that it is possible to increase inductance while ensuring magnetic path of the magnetic flux φ, thereby improving antenna characteristics. Furthermore, the first to fourth metallic layers 12A₁, 12A₂, 12B₁, and 12B₂ each have a loop pattern obtained by removing a center portion of a solid pattern, so that the floating capacitance between the first to fourth metallic layers 12A₁, 12A₂, 12B₁, and 12B₂ and the antenna coil 11 can be reduced, thereby making it easy to achieve antenna frequency matching.

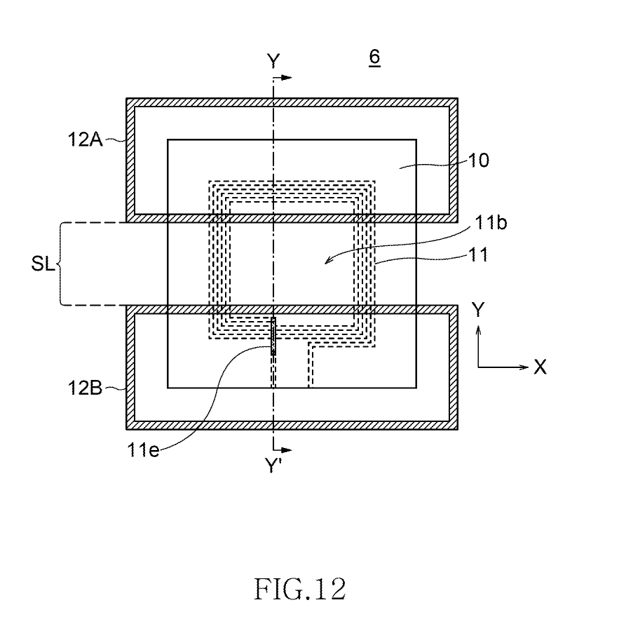

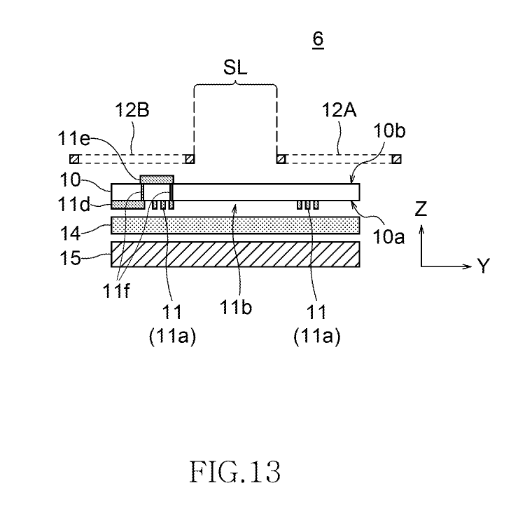

FIGS. 12 and 13 are views each illustrating a configuration of an antenna device according to a sixth embodiment of the present invention. FIG. 12 is a plan view, and FIG. 13 is a cross-sectional view.

As illustrated in FIGS. 12 and 13, an antenna device 6 according to the present embodiment is a modification of the first embodiment and is characterized in that the first and second metallic layers 12A and 12B are provided above the other main surface 10b of the substrate 10 so as to be separated from the substrate 10. Since the first and second metallic layers 12A and 12B do not contact the substrate 10, they are not restricted in terms of size. Thus, the loop of each of the first and second metallic layers 12A and 12B largely protrude outward from an area of the substrate 10. As a result, it is possible to generate a loop magnetic field larger than that in the antenna device 1 of the first embodiment, thereby further increasing a communication distance.

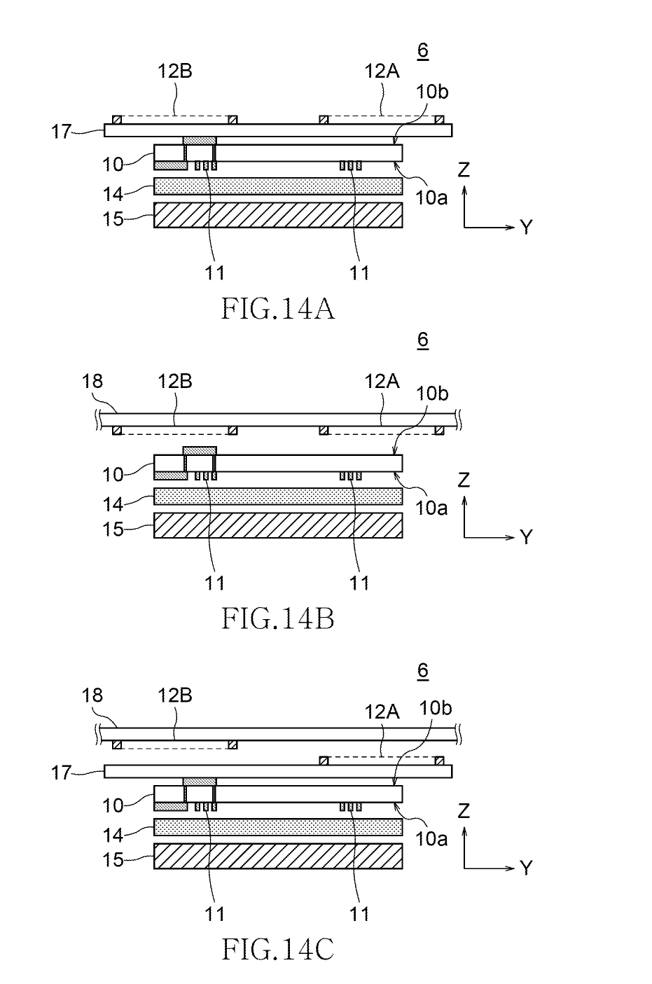

FIGS. 14A to 14C are cross-sectional views illustrating variations of arrangement of the first and second metallic layers 12A and 12B in the antenna device 6.

In the antenna device 6 illustrated in FIG. 14A, there is provided a substrate 17 bonded to the substrate 10 on which the antenna coil 11 is formed, and the first and second metallic layers 12A and 12B are formed on the substrate 17. In the antenna device 6 illustrated in FIG. 14B, the first and second metallic layers 12A and 12B are formed on a rear surface of a housing 18 of a mobile electronic device such as a smartphone in which the antenna device is mounted. In the antenna device 6 illustrated in FIG. 14C, the first metallic layer 12A is formed on the substrate 17, and the second metallic layer 12B is formed on the rear surface of the housing 18. As described above, the first and second metallic layers 12A and 12B may be formed on the same plane or on different planes.

As described above, in the antenna device 6 according to the present embodiment, the first and second metallic layers 12A and 12B make the loop of the magnetic flux φ of the antenna coil 11 widely circulate, thereby increasing a communication distance from the antenna device 1 to an antenna of an apparatus at a communication partner side. Further, the first and second metallic layers 12A and 12B are each formed into a loop pattern, thereby reducing the floating capacitance between the first and second metallic layers 12A and 12B and the antenna coil 11, which can make it easy to achieve antenna frequency matching.

The sixth embodiment is a modification of the first embodiment, and a similar modification can be applied to the second to fifth embodiments. That is, the first and second metallic layers 12A and 12B may be provided so as to be separated from the substrate 10 in the second embodiment, the second metallic layer 12B may be provided so as to be separated from the substrate 10 in the third embodiment, the first, second and center metallic layers 12A, 12B, and 12C maybe provided so as to be separated from the substrate 10 in the fourth embodiment, and the first to fourth metallic layers 12A₁, 12A₂, 12B₁, and 12B₂ may be provided so as to be separated from the substrate 10 in the fifth embodiment.

It is apparent that the present invention is not limited to the above embodiments, but may be modified and changed without departing from the scope and spirit of the invention.

For example, although the bridge section 11e of the antenna coil 11 is formed on the other main surface 10b of the substrate 10 in the above embodiments, the present invention is not limited to this configuration. For example, the bridge section 11e may be formed on the spiral pattern 11a formed on the one main surface 10a of the substrate 10 through an insulating film made of PET in an overlapping manner. In this case, although two metallic layers are partially formed on the one main surface 10a side of the substrate 10, the antenna coil according to the present invention may have such a configuration.

Further, although the antenna coil 11 is constituted by a spiral pattern with several turns in the above embodiments, the number of the turns in the loop pattern may be less than one turn. That is, the antenna coil 11 only needs to be a loop-shaped or a spiral-shaped planar coil pattern.

What is claimed is:

1. An antenna device comprising:
a substrate;
an antenna coil formed into loop-shaped or spiral-shaped on the substrate; and
first and second metallic layers disposed so as to overlap with the antenna coil in a planar view and to form a slit sandwiched the first and second metallic layers, wherein
the slit overlaps with an inner diameter portion of the antenna coil,
at least one of the first and second metallic layers is formed into a loop shape having an opening, and
the antenna coil overlaps with the opening of at least one of the first and second metallic layers in a planar view.

2. The antenna device as claimed in claim 1, wherein
both of the first and second metallic layers are formed into a loop shape having an opening in a planar view, and
the antenna coil is disposed so as to overlap with each of the openings of the first and second metallic layers in a planar view.

3. The antenna device as claimed in claim 2, wherein
the antenna coil is formed on one main surface of the substrate, and
the first and second metallic layers are formed on the other main surface of the substrate.

4. The antenna device as claimed in claim 2, further comprising third and fourth metallic layers provided so as to overlap with the antenna coil in a planar view, wherein
both of the third and fourth metallic layers are formed into a loop shape having an opening in a planar view, and
the antenna coil is disposed so as to overlap with each of the openings of the first to fourth metallic layers in a planar view.

5. The antenna device as claimed in claim 1, wherein
the first metallic layer has a solid metallic surface as a whole, and
the second metallic layer is formed into a loop shape having an opening in a planar view.

6. The antenna device as claimed in claim 5, wherein
the antenna coil is formed on one main surface of the substrate, and
the first and second metallic layers are formed on the other main surface of the substrate.

7. The antenna device as claimed in claim 5, wherein
the antenna coil is formed on one main surface of the substrate,
the first metallic layer is provided so as to be separated from the substrate, and
the second metallic layer is formed on the other main surface of the substrate.

8. The antenna device as claimed in claim 1, wherein
a line width of the loop shape of at least one of the first and second metallic layers is substantially constant over the entire periphery thereof.

9. The antenna device as claimed in claim 1, further comprising:
a metallic body provided so as to overlap with the antenna coil in a planar view; and
a magnetic sheet provided between the antenna coil and the metallic body.

10. The antenna device as claimed in claim 1, further comprising a center metallic layer provided so as to overlap with at least a center portion of the inner diameter portion of the antenna coil,
wherein the first and second metallic layers are disposed on both sides of the center metallic layer, respectively, so as to be sandwiched between the first and second metallic layers.

11. An antenna device comprising:
a substrate having a first surface and a second surface opposite to each other;
a coil pattern formed on the first surface of the substrate; and
a loop pattern formed on the second surface of the substrate, wherein
the substrate having an inward portion surrounded by the coil pattern in a planar view and an outward portion surrounding the coil pattern in a planar view, and
the loop pattern surrounding a part of the inward portion, apart of the coil pattern, and apart of the outward portion in a planar view.

12. The antenna device as claimed in claim 11, wherein the part of the outward portion is greater than the part of the inward portion.

13. The antenna device as claimed in claim 11, further comprising a metallic pattern overlapping with another part of the inward portion, another part of the coil pattern, and another part of the outward portion in a planar view.

14. The antenna device as claimed in claim 13, wherein the metallic pattern is formed on the second surface of the substrate.

15. The antenna device as claimed in claim 13, wherein the metallic pattern is a loop-shaped.

16. The antenna device as claimed in claim 13, wherein the metallic pattern is a solid-shaped.

17. A device comprising:
a metallic coil pattern formed on a first plane; and
a metallic loop pattern formed on a second plane different from the first plane, wherein
the first plane and the second plane are substantially parallel to each other,
the first plane has a first inward portion surrounded by the coil metallic pattern,
the second plane has a second inward portion surrounded by the metallic loop pattern, and
the metallic coil pattern and the metallic loop pattern are overlapped with each other when viewing from a predetermined direction crossing to the first and second planes so that a part of the first inward portion and a part of the second inward portion are overlapped with each other.

18. The device as claimed in claim 17, further comprising another metallic loop pattern,
wherein the another metallic loop pattern is provided so as to overlap with the metallic coil pattern and so as not to overlap with the metallic loop pattern.

19. The device as claimed in claim 17, further comprising a solid loop pattern,
wherein the metallic solid pattern is provided so as to overlap with the metallic coil pattern and so as not to overlap with the metallic loop pattern.

20. The device as claimed in claim 19, wherein the solid loop pattern is formed on a third plane different from the first and second planes.
